(19) United States
(12) Patent Application Publication
(10) Pub. No.: US 2003/0212783 A1
(43) Pub. Date: Nov. 13, 2003

(54) Network device administration apparatus and method, computer program, and computer-readable storage medium

(75) Inventor: Testsuo Sakai, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/422,731

(22) Filed: Apr. 25, 2003

(30) Foreign Application Priority Data
May 8, 2002 (JP) 2002-132841

(51) Int. Cl. G06F 15/173

(52) U.S. Cl. 709/223

(57) ABSTRACT

The present invention enables grouping of network devices with an easy operation so that it is convenient to download various setting information to the plural network devices with a single operation. In grouping the network devices, the number of network devices registerable in one group, and a condition for registering the network devices, such as grouping by an order of IP addresses or subnet addresses, are set. In step S1301, the set information is read. Then, network devices satisfying the condition are registered within the maximum number (S1305). If the number of network devices exceeds the maximum number, a new group is generated in step S1302, and network devices are registered in this group.

### FIELD OF THE INVENTION

The present invention relates to a network device administration apparatus and method, a computer program, and a computer-readable storage medium.

### BACKGROUND OF THE INVENTION

Recently, as networks come into wide use, users share resources on the networks. In particular, a file server is provided to share files, or a printer (including a single-unit printer or a printer included in a multi-function apparatus) is connected to a network to allow each client (personal computers or the like) to perform printing at liberty, thereby increasing an operation rate.

In a case where such network is employed in a company, there are plural printers in each department of the company and the types of printers (language) vary.

Meanwhile, there are many types of fonts that can be used in documents subjected to printing, and new fonts are still emerging. To print such documents, a printer must store many types of fonts. Therefore, a printer must include a large-capacity memory for storing fonts. For this reason, a cost increase in the printers is inevitable. In view of this, several proposals for solving this problem by downloading fonts to a printer have been made.

According to this proposal, a user can download frequently used fonts to a printer, and can achieve efficient use of the memory.

Assuming utilization of printers in a company, it is preferable that printers belonging to one department output the same font. Therefore, it is preferable to unify the fonts stored in the printers, which belong to a department or are located in a limited area.

For this purpose, the same font is downloaded to each of the printers. However, if there are a large number of printers, the amount of downloading work cannot be disregarded. Particularly in a case where each department of a company uses a different font, management thereof requires much effort.

### SUMMARY OF THE INVENTION

The present invention has been proposed to solve the above problem, and has as its object to provide a network device administration apparatus and method, a computer program, and a computer-readable storage medium, which enable grouping of network devices with an easy operation so that various setting information can be downloaded to the plural network devices with a single operation.

In order to achieve the foregoing object, the network device administration apparatus according to the present invention has the following configuration. More specifically, the present invention provides a data processing apparatus for downloading desired printer resource data to a plurality of network devices connected to a network, comprising: first setting means adopted to set a number of network devices registerable in a device group, which is generated in order to collectively administrate a plurality of network devices as a download target; second setting means adopted to set a grouping condition for registering a network device in the device group; and registering means adopted to register network devices within the number set by the first setting means, in accordance with the condition set by the second setting means.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a view showing an operation environment of a download program;

FIG. 2 is a view showing a configuration of a PC;

FIG. 3 shows an example of a main screen of a downloader;

FIG. 4 shows an example of a screen for generating a device group;

FIG. 5 shows an example of a screen displaying a device list;

FIG. 6 shows an example of a screen for setting the number of devices registerable in a group;

FIG. 7 shows an example of a screen for setting of grouping;

FIG. 8 shows an example of a referable device list;

FIG. 9 shows an example in which groups are generated in order of IP addresses;

FIG. 10 shows an example in which groups are generated in units of subnets;

FIG. 11 shows an example in which groups are generated in units of device models;

FIG. 12 shows an example in which groups are generated in units of PDL types;

FIG. 13 is a flowchart showing a process of grouping; and

FIG. 14 is a view showing a storage state of download target data according to this embodiment.

### DETAILED DESCRIPTION OF THE PREFERRED EMBODIMENT

A preferred embodiment of the present invention will now be described in detail in accordance with the accompanying drawings. First, the basic part of the embodiment is described.

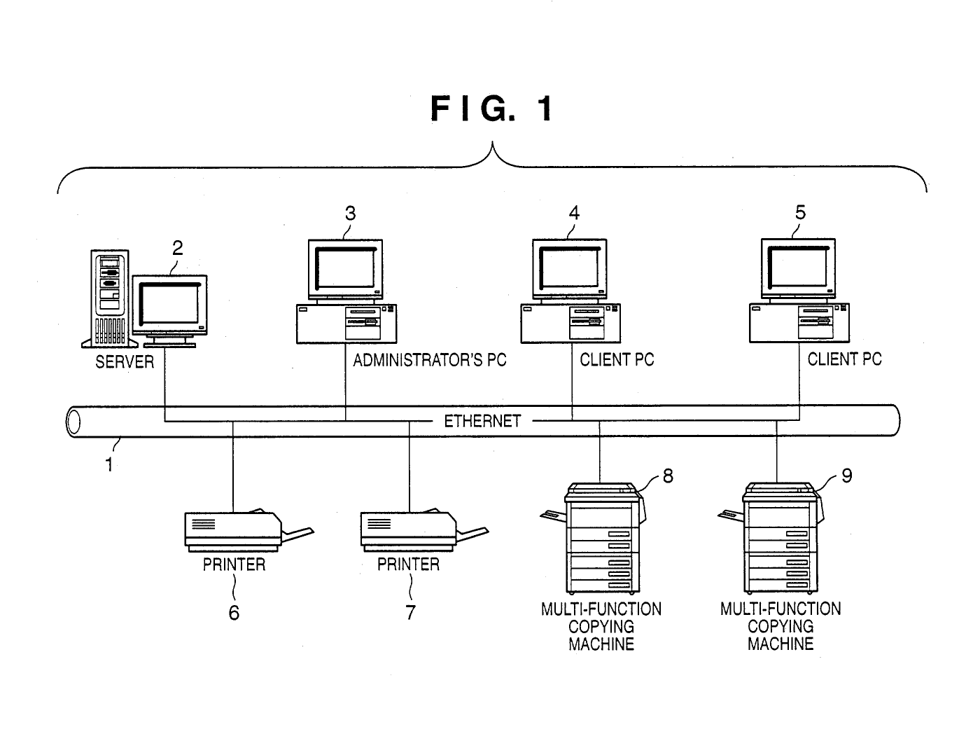

FIG. 1 shows an example of an operation environment of a download program, which is now described below. Referring to FIG. 1, numeral 1 denotes a network. For a physical layer of the network, Ethernet or LocalTalk may be employed. This embodiment assumes that Ethernet is used.

Note that a “network” in this embodiment indicates one or any combination of a physical cable, electric signals sent through the cables, and a protocol that realizes data exchange by a combination of electric signals. Normally, a network is a generic term of these elements.

Numeral 2 denotes a server computer. Numeral 3 denotes an administrator's personal computer (hereinafter, a personal computer will be referred to as a PC). In the administrator's PC 3, a download program (hereinafter referred to as a downloader), which performs downloading of fonts to a printer or a multifunction copying machine, is operated.

Numerals 4 and 5 denote a client PC used by general users, which is connected to the network (although FIG. 1 shows only two PCs, any numbers of PCs may be connected). Note that the administrator's PC may be used as a client PC. The downloader may be operated in the client PC.

Numerals 6 and 7 denote a printer, which is connected to the network 1, receives a print command from the client PC 4 or 5, and performs print processing according to the command. Further, the printers 6 and 7 receive a font-downloading command and download data from the downloader, and perform downloading of font data according to the command.

Numerals 8 and 9 denote a multi-function copying machine, including an image scanner function, a printer function, and a facsimile function. By combining one or plural functions, it can be used as a copying machine, a printer, a scanner, or a facsimile. Further, the multifunction copying machines 8 and 9 receive a font-downloading command and download data from the downloader, and perform downloading of font data according to the command.

Besides the configuration shown in FIG. 1, the simplest example of a downloader's operation environment is a configuration that includes: one PC serving as an administrator's PC and a client PC; and a printer or a multi-function copying machine directly connected to the PC. Since this configuration is very simple, drawing thereof is not provided.

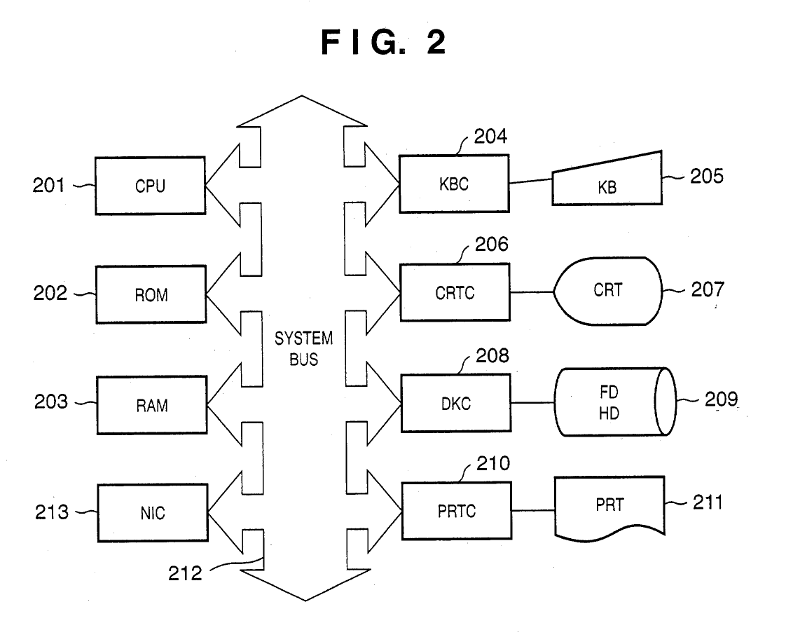

Next, a configuration of the administrator's PC 3 and a flow of a process of the downloader operating in the PC 3 are described with reference to FIG. 2.

The downloader is stored (installed) as a setup program or the like in an external storage area 209. The downloader is started when an administrator downloads a font to the printer or multi-function copying machine, and resides in the RAM 203. The downloader looks up resource data to be downloaded in the external storage device 209, converts the resource data into a downloadable form, and temporarily stores the converted data in the RAM 203 or external storage device 209. The converted downloadable data (resource data) includes font data, form (macro) data, color resource data, and so forth. There should be no need to explain about font data. Macro data is provided to have a printer (including a multi-function machine) execute predetermined processing. A typical example thereof is data constructed with commands for generating a form. In other words, once the macro data is registered in a printer, it is possible to have the printer generate a form image by designating information specifying the macro data (macro name), and an image based on print data can be superimposed on the form image. Therefore, by registering macro data compliant with plural printers, it is possible to have any of the plural printers output an intended image. Moreover, color resource data is provided to unify color reproducibility. In a case of monochrome printers, for instance, when a command for printing in red is described in PDL, the printers are controlled to use the same mesh pattern to unify the color.

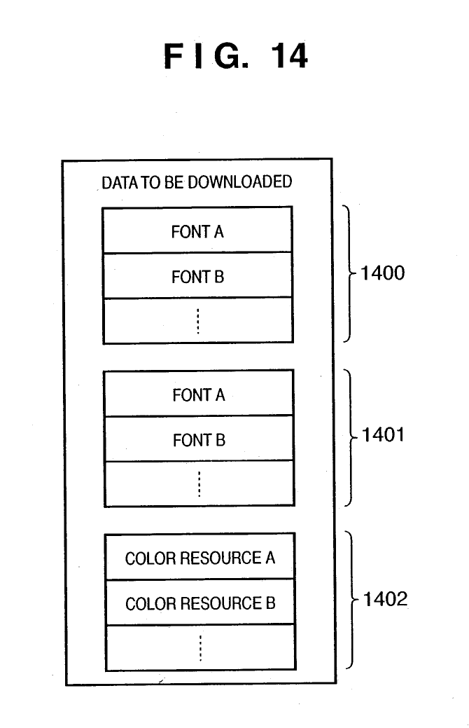

The external storage device 209 is, for instance a hard disk device. In the storage device 209, a large number of font data 1400, form data 1401, color resource data 1402 are stored in advance as shown in FIG. 14. A group of one or plural printers, which intend to obtain the aforementioned data (one or plural data), performs downloading when an administrator starts up the downloader. At this stage, the data is converted to a form appropriate for each printer as mentioned above, and the converted data is transferred.

The downloader transfers the data in a downloadable form, which is generated as mentioned above, to the printer or multi-function copying machine and executes download processing. To the printer or multi-function copying machine connected to the network, the download data transfer is performed through the network interface card (NIC) 213 using a transfer protocol, such as LPR or the like. To a locally-connected printer or multi-function copying machine, such as the PRT 211, the data in a downloadable form is simply transferred and download processing is executed.

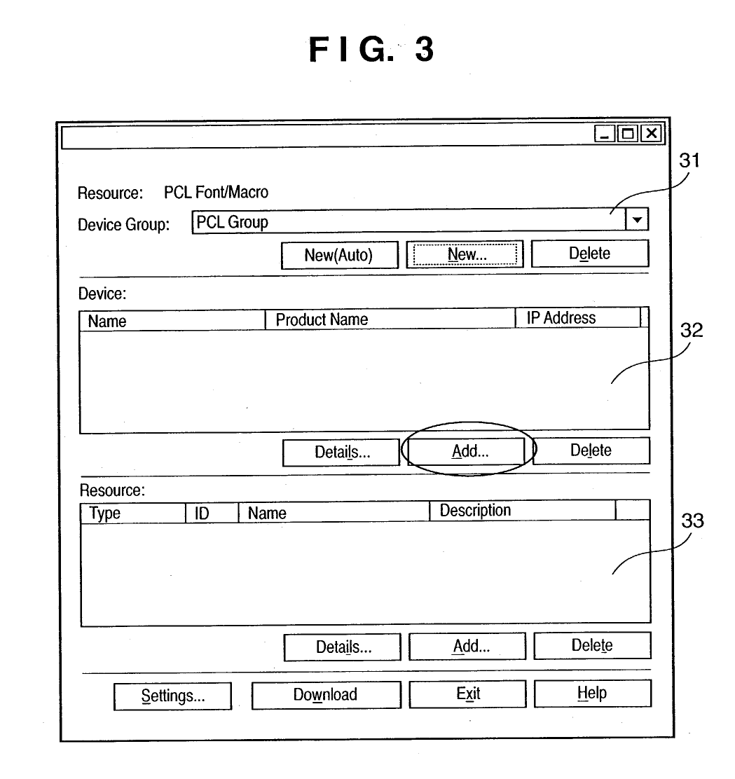

Next, a specific operation of the downloader according to the embodiment is described with reference to FIG. 3 and other related drawings.

FIG. 3 shows an example of a main screen (window) of a download program in the administrator's PC 3. Although this window shows a GUI of MS-Windows® as an example, the GUI is not limited to this.

In this window, numeral 31 denotes a combo box. By clicking the triangle mark on the right end, a registered group list is displayed and a desired group name can be selected from the list. Numerals 32 and 33 denote a list box. In the area 32, a list of devices that belong to the selected group is displayed. In the area 33, a list of downloadable data (font, form, color resource shown in FIG. 14) is displayed.

In the normal procedure, one of the groups (already registered groups) subjected to downloading is selected. When devices (printers in this embodiment) that belong to the group are displayed in the area 32, one or plural data subjected to downloading are selected. Then, the “Download” button on the bottom of the window is clicked with a mouse®. By this operation, the designated data is downloaded to the devices that belong to the group.

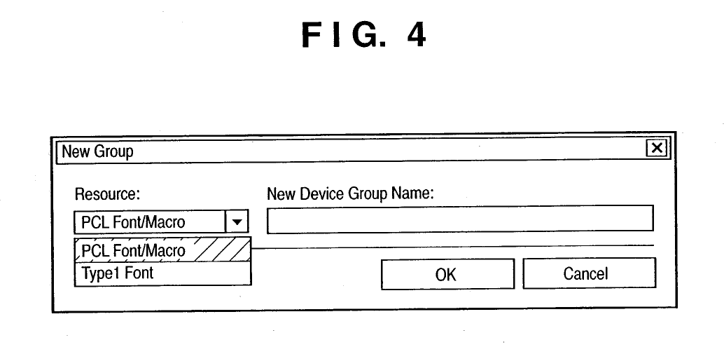

As a result, a GUI window shown in FIG. 4 is displayed. On the left side of the dialogue box, there is a combo box for selecting the type of resource data for the device group. In this example, the type of resource data is selected from “PCL Font/Macro” (trademark of Hewlett-Packard Co. PCL is a printer language recommended by Hewlett-Packard Co.) and “Type 1 Font” (postscript developed by Adobe Systems Inc.). Note although two types of printers are shown herein, the present invention is not limited to this, but any numbers of types of printers may be included. In some cases, color printers and monochrome printers may be separately shown. Then, a group name to be registered is inputted by a keyboard, and the OK button is clicked.

The group name may be of a name convenient for the administrator. For instance, if the group to be registered is the printers in a department of a company (e.g., Administration Department First Division), the name of the department may be used. If the group belongs to a certain story of a building, the story number may be designated as a character string.

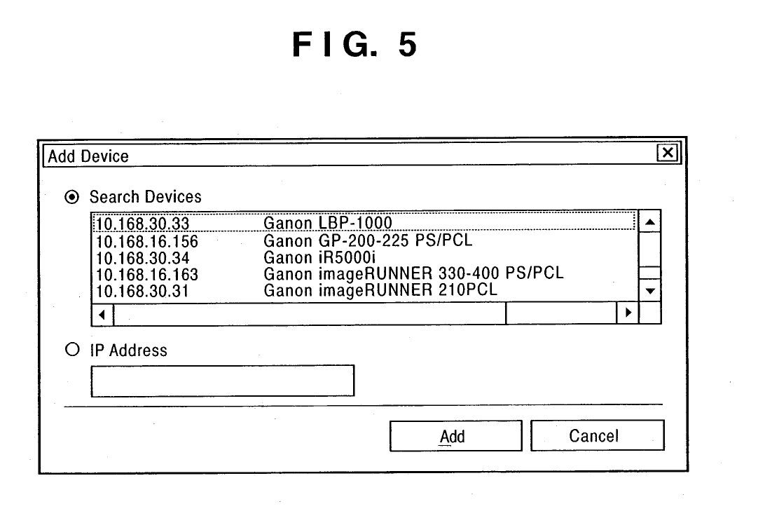

When the group name is designated and the OK button is clicked (not enabled unless a group name is inputted), printers connected to the network are searched to find one that matches the type selected in FIG. 4. Then, the result of the search is displayed as a list including the IP addresses and device names. For example, if “PCL Font/Macro” is selected as a reference of the group, a list of printers adopting PCL Font/Macro are displayed as shown in FIG. 5. By selecting desired (one or plural) printers, printers that belong to the group can be determined.

According to the foregoing procedure, when grouping is performed for the first time, several groups must be set, and printers to be registered in each of the groups must be set one by one.

The present embodiment includes a mode for automatically performing group addition. To execute this mode, the button “Settings . . . ” on the bottom of the window shown in FIG. 3 is clicked.

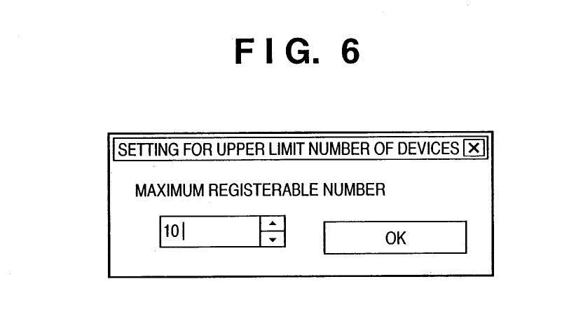

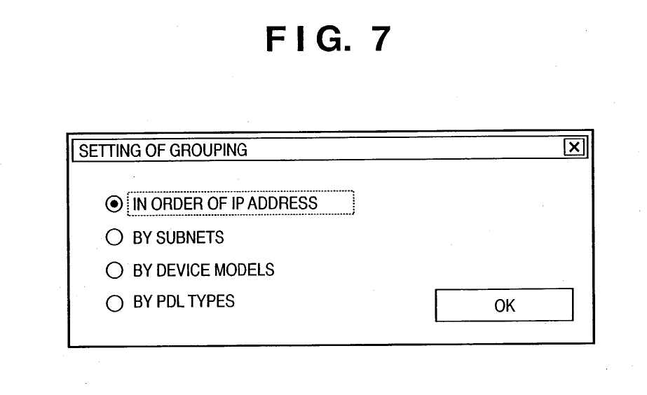

As a result, a GUI window (not shown) is displayed (GUI screen without the combo box for selecting the type of resource data shown in FIG. 5) to allow inputting a group name to be registered. When the OK button is clicked on the GUI window, the inputted group name is stored in the RAM 203 or external storage device 209. Then, a GUI window shown in FIG. 6 is displayed, and an upper limit value of the number of printers registerable in the group to be generated is set. After the number is set and the OK button is clicked, a GUI window shown in FIG. 7 is displayed. Referring to the GUI window in FIG. 7, the administrator determines as to what category the printers subjected to administration should be grouped, and selects one category. As the category of grouping, this embodiment includes “in order of IP addresses,” “by subnets,” “by device models,” and “by PDL types.” Other categories may be provided, and the number of categories is not limited to this.

For instance, in a case of a network using TCP/IP in a company or the like, an administrator does not control a large number of PCs in one network address. Instead, these PCs are divided into subnets for each department, for each story of the building, or for each building, and each of the LANs is connected through a router or a gateway or the like. Naturally, printers are provided to each of the LANs. In this case, it is convenient to group the printers “by subnets.”

In a case of a middle-size network, there may be a case where PCs and printers located on the first floor are controlled by using IP addresses of 192.168.1.1 to 192.168.1.30 and PCs and printers located on the second floor are controlled by using IP addresses of 192.168.1.51 to 192.168.1.80. In such case, it is convenient to group the printers “in order of IP addresses.” The same concept applies to a case of grouping “by device models” and “by PDL types.”

When a category is selected and the OK button is clicked in the GUI window shown in FIG. 7, contents of setting so far (the maximum number allowed to register, category for grouping) are written in the external storage device 209, and according to necessity they are read into the RAM 203 and referred by actual processing. Based on this information, a group registration process described below is started.

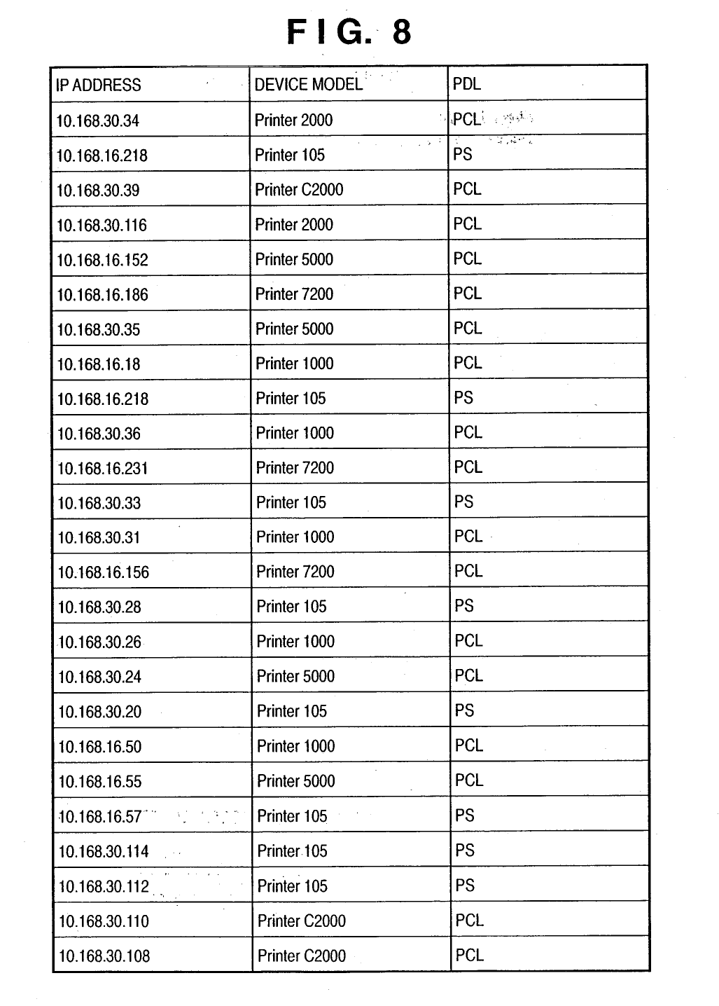

FIG. 8 shows an example of a list of devices (printers) connected to the network according to the present embodiment. In this example, assume that 25 printers are connected to the network (including a case constructed with plural LANs), and each printer has an IP address shown in FIG. 8. To simplify the description, the printers have two types (PCL, PS) of page description language (PDL) to interpret, and there are two types of subnets. As a matter of course, the numbers and types do not limit the present invention.

The following description is provided with an assumption that the number of devices registerable in one group is 10.

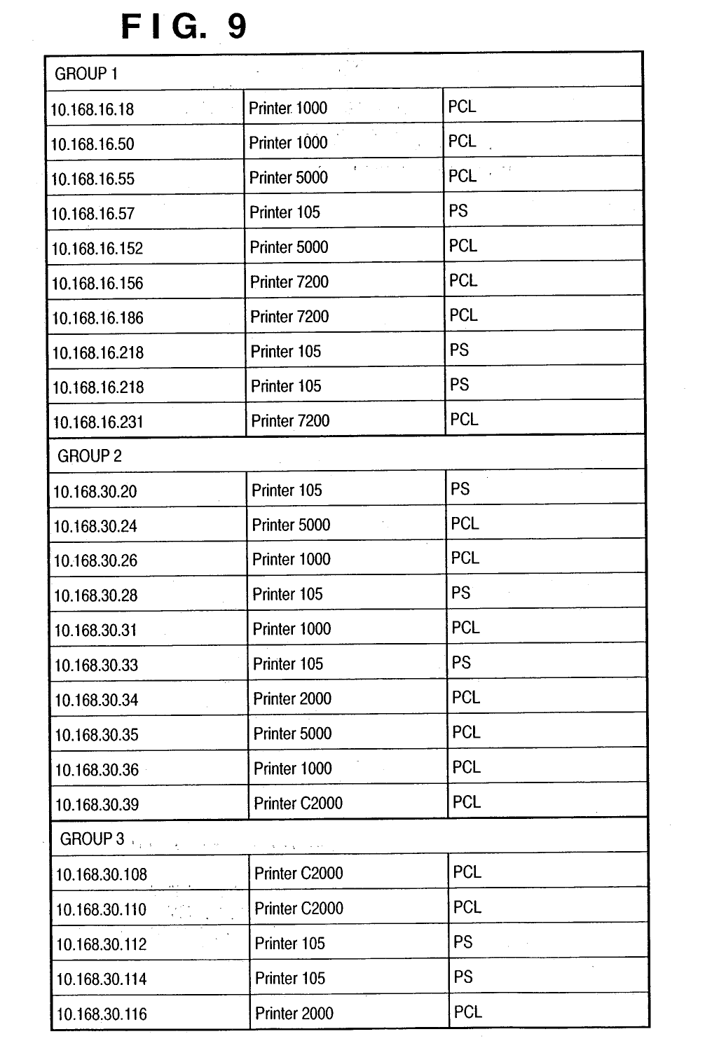

FIG. 9 shows a result of device group information generated “in order of IP addresses.” As can be seen in FIG. 9, devices are grouped in units of 10 devices in order of IP addresses. The result thereof is registered in the HD 209 of the administrator's PC 3 in a table form shown in FIG. 9. If there is a device exceeding the number of devices registerable in one group, the inputted “group name+number” is registered as a group name. Note that the group name can be corrected or changed at liberty in post processing.

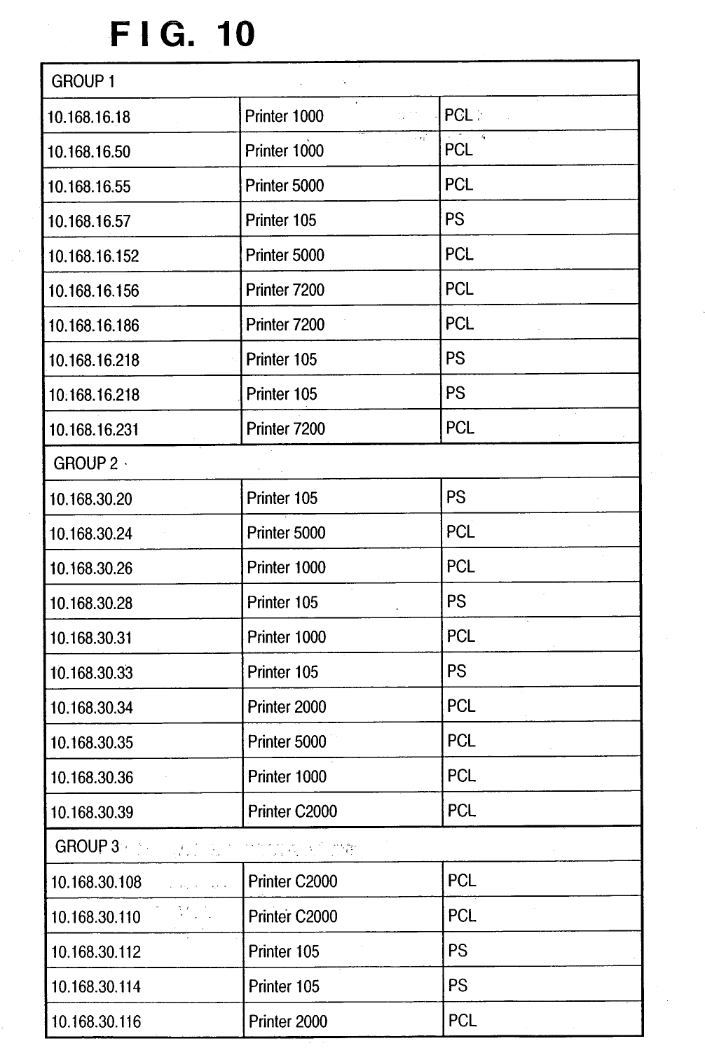

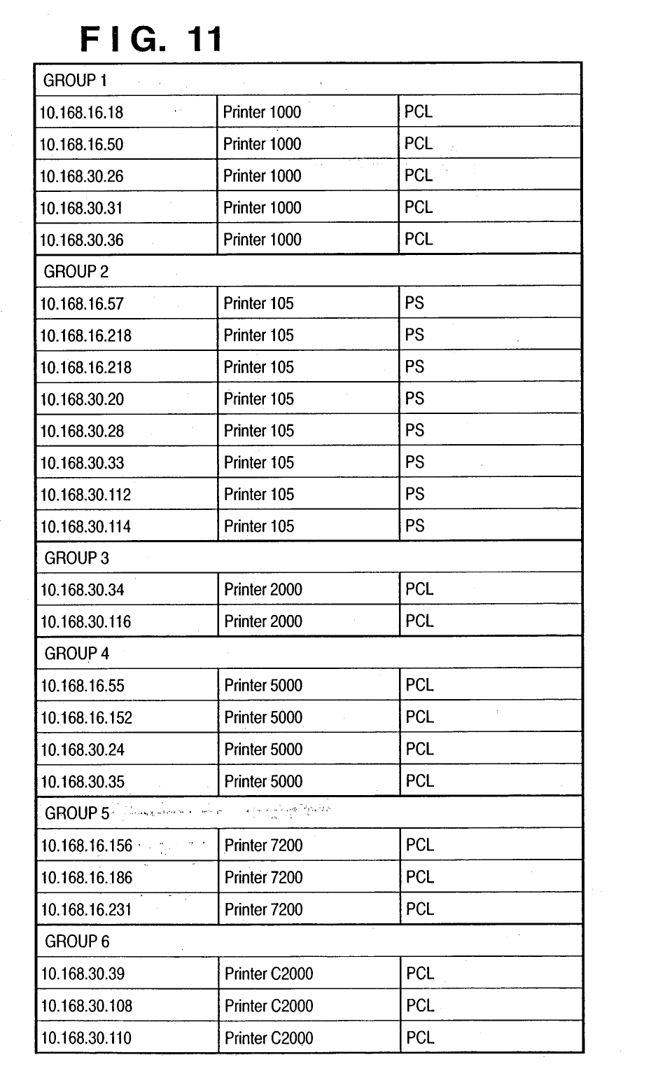

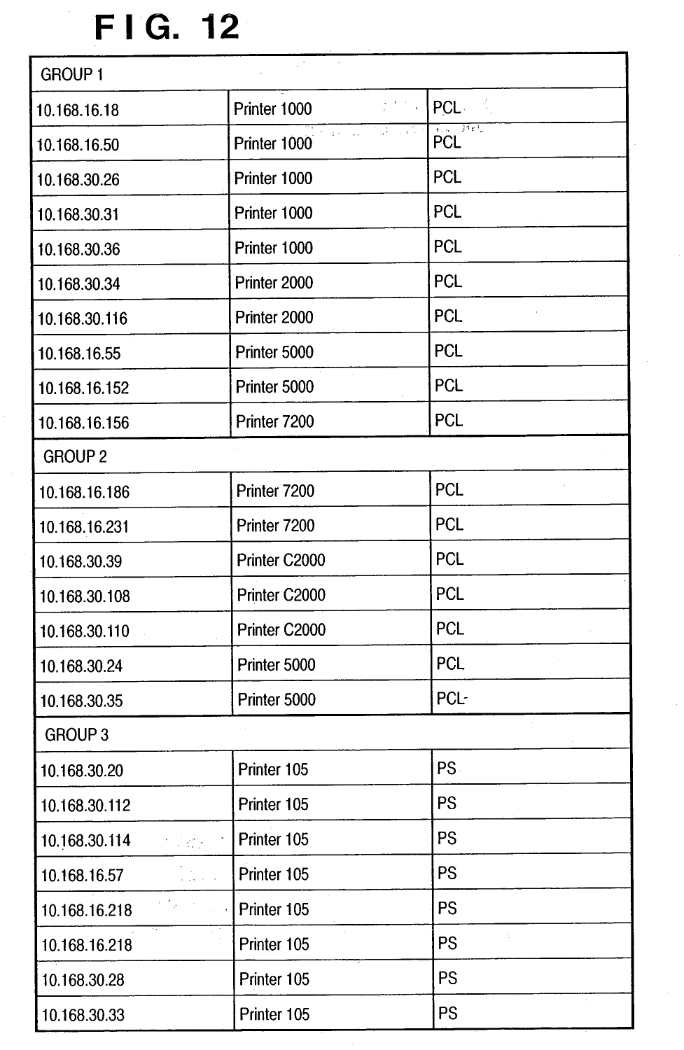

FIG. 10 shows a result of device group information generated in units of subnets. FIG. 11 shows a result of device group information generated in units of device models. FIG. 12 shows a result of device group information generated in units of PDL types.

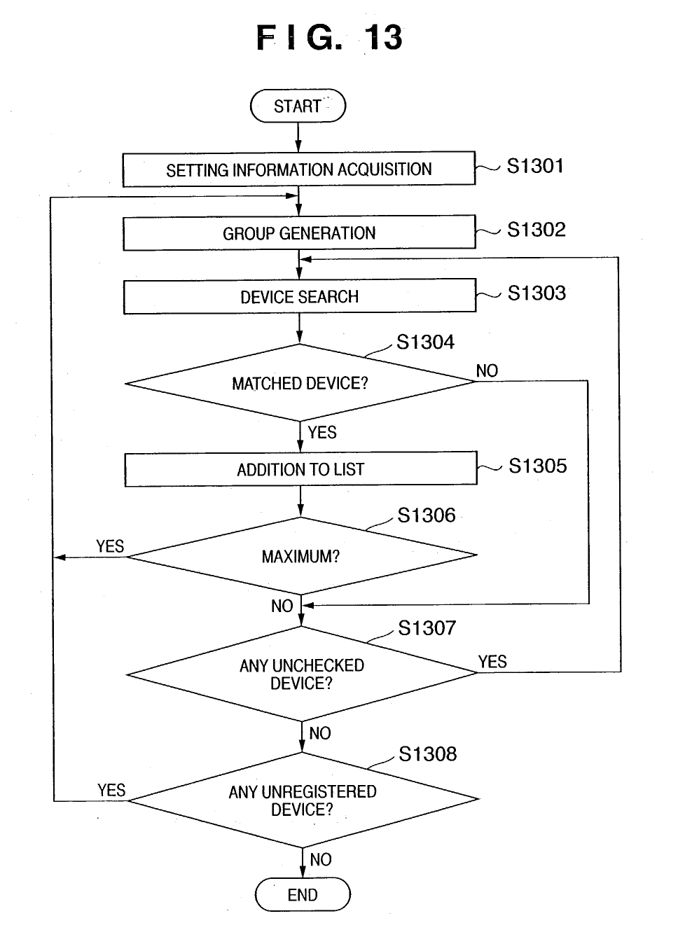

Next, an automatic grouping procedure is described with reference to the flowchart in FIG. 13. Note that a program according to the flowchart forms a part of the downloader. Assume that the group name, the number of devices registerable in a group, and the type of category are set and registered in the external storage device 209 prior to the following processing.

In step S1301, information related to the maximum number of devices registerable in one group, which has been set using the screen showing the user interface in FIG. 6, is read out of the RAM 203 or external storage device 209 as necessary and acquired. As mentioned above, the number of devices registerable may be set by a user using the screen shown in FIG. 6, or the number may be determined in advance and set in the RAM 203 at the time of initialization of the downloader. Next, setting information of a grouping category, which has been set using the user interface shown in FIG. 7, is read out of the RAM 203 or external storage device 209. In step S1302, a group name (character string) is acquired from the RAM 203 or external storage device 209.

In step S1303, information of the device to be processed next is acquired from the device list shown in FIG. 8. In step S1304, it is determined whether or not the information of the device acquired in step S1303 matches the grouping setting information acquired in step S1301. For instance, in a case where devices are grouped in order of IP addresses, it is determined whether or not the IP address is the youngest of all devices not yet added in the group list. In a case where devices are grouped by subnets, whether or not the subnet address is the same is determined. In a case where devices are grouped by device models, whether or not the device model is the same is determined. In a case where devices are grouped by PDL types, whether or not the type of PDL is the same is determined. If a match is determined, the control proceeds to step S1305, whereas if a match is not determined, the control proceeds to step S1307.

When a matched device is determined in step S1304, the information of the device is added to the device information list of the group in step S1305. Next, in step S1306, it is determined whether or not the number of devices exceeds the maximum number of devices registerable in one group, which is acquired in step S1301. If the number reaches the maximum number, the control proceeds to step S1302 to generate the next group. Whereas, if the number has not reached the maximum number, the control proceeds to step S1307 where it is determined whether or not there is any unchecked device in the device list shown in FIG. 8. If there is an unchecked device, the control proceeds to step S1303 to repeat the foregoing process. Whereas, if all devices have been checked, the control proceeds to step S1308.

In step S1308, it is determined whether or not there is any unregistered device in the device list. If there is an unregistered device, the control proceeds to step S1302 to repeat the foregoing process until all devices are registered in a group.

As described above, according to the present embodiment which facilitates grouping of printers in the network, it is possible to simplify downloading work of fonts, forms or the like. Further, since the number of printers belonging to one group is not fixed but can be changed by user setting, the number of printers can be set in accordance with a situation of each user.

In other words, since network devices can be easily grouped and the number of network devices belonging to each group can be set at liberty, network devices can be grouped according to the size of the network. Therefore, in a case where printers are employed as the network devices, information such as fonts or the like can be downloaded all at once to the printers that belong to a certain group.

Although the above embodiment has described a printer as an example of the network device, the present invention is not limited to printers, because there is a case where various control information is set in a network scanner or the like.

As a technique for acquiring network device information (type of device, type of printer, or the like), for instance, Management Information Base (MIB) or the like may be used.

The main processing of the above-described embodiment is characterized by the program operating on the administrator's PC 3. As mentioned above, since the PC 3 can be realized by a general-purpose data processing apparatus, such as a personal computer, and the program realizing the above-described processing operates as an application program, such computer program constitutes the present invention.

Furthermore, normally a computer program is executed by inserting a storage medium, e.g., a floppy® disk, CD-ROM or the like, into an apparatus and copying or installing the program in the apparatus. Therefore, such storage medium also constitutes the present invention.

Furthermore, the present invention is also applicable to a combination of a computer program and appropriate hardware (encoding circuit or the like).

As has been set forth above, the present invention enables grouping of network devices with an easy operation so that it is convenient to download various setting information to the plural network devices with a single operation.

As many apparently widely different embodiments of the present invention can be made without departing from the spirit and scope thereof, it is to be understood that the invention is not limited to the specific embodiments thereof except as defined in the claims.

The present invention is not limited to the above embodiments and various changes and modifications can be made within the spirit and scope of the present invention. Therefore, to apprise the public of the scope of the present invention, the following claims are made.

What is claimed is:

1. A data processing apparatus for downloading resource data, to be used by network devices, to a plurality of network devices connected to a network, comprising:
first setting means adopted to set a number of network devices registerable in a device group, which is generated in order to collectively administrate a plurality of network devices as a download target;
second setting means adopted to set a grouping condition for registering a network device in the device group; and
registering means adopted to register network devices as one device group within the number set by said first setting means, in accordance with the condition set by said second setting means.

2. The apparatus according to claim 1, further comprising means adopted to generate a new group and continue registration, in a case where there are more numbers of network devices than the number of devices set by said first setting means.

3. The apparatus according to claim 1, wherein said second setting means includes means adopted to select which order is to be adopted in registration, from an order of IP addresses allocated to each network device, an order of subnet addresses, device models, and types of language used.

4. The apparatus according to claim 1, wherein the network device has a printing function.

5. A data processing method for downloading resource data to a plurality of network devices connected to a network, comprising:
a first setting step of setting a number of network devices registerable in a device group, which is generated in order to collectively administrate a plurality of network devices as a download target;
a second setting step of setting a grouping condition for registering a network device in the device group; and
a registering step of registering network devices as one device group within the number set in said first setting step, in accordance with the condition set in said second setting step.

6. A computer program for a data processing apparatus, which downloads resource data to a plurality of network devices connected to a network, said program functioning as:
first setting means adopted to set a number of network devices registerable in a device group, which is generated in order to collectively administrate a plurality of network devices as a download target;
second setting means adopted to set a grouping condition for registering a network device in the device group; and
registering means adopted to register network devices as one device group within the number set by said first setting means, in accordance with the condition set by said second setting means.

7. A computer-readable storage medium storing the computer program described in claim 6.

8. A data processing apparatus for downloading resource data, to be used by network devices, to a plurality of network devices connected to a network, comprising:
administration means adopted to collectively administrate a plurality of network devices as a download target, based on a device group including a plurality of network devices;
condition setting means adopted to set a grouping condition indicative of a condition of a network device to be registered in the device group; and
registering means adopted to register network devices as one device group in the device group in accordance with the condition set by said condition setting means,
wherein said administration means downloads the resource data to the network devices included in the device group.

9. A data processing method for downloading resource data, to be used by network devices, to a plurality of network devices connected to a network, said method comprising:
a step of setting a grouping condition indicative of a condition of a network device to be registered in a device group for collectively administrating a plurality of network devices as a download target;
a step of registering network devices in the device group in accordance with the set condition; and
a step of downloading the resource data to the network devices included in the device group.

10. A program for downloading resource data, to be used by network devices, to a plurality of network devices connected to a network, said program causing a computer to execute:
a step of setting a grouping condition indicative of a condition of a network device to be registered in a device group for collectively administrating a plurality of network devices as a download target;
a step of registering network devices in the device group in accordance with the set condition; and
a step of downloading the resource data to the network devices included in the device group.
